(19) United States
(12) Patent Application Publication
(10) Pub. No.: US 2007/0292798 A1
(43) Pub. Date: Dec. 20, 2007

(54) Curable Composition and Elastic Roller Therefrom

(76) Inventors: Jun Kamite, Shiga (JP); Takashi Kuchiyama, Shiga (JP)

Correspondence Address: BRINKS HOFER GILSON & LIONE, P.O. BOX 10395, CHICAGO, IL, 60610, US

(21) Appl. No.: 10/581,392

(22) PCT Filed: Nov. 19, 2004
(86) PCT No.: PCT/JP04/17658

§ 371 Date: Mar. 27, 2007

(30) Foreign Application Priority Data
Dec. 2, 2003 (JP) 2003-403852
Dec. 25, 2003 (JP) 2003-431660

(51) Int. Cl. C08L 83/05; C08L 101/02; F16C 13/00; G03G 15/00

(52) U.S. Cl. 430/97

(57) ABSTRACT

There has been a problem, in rollers to be incorporated in image forming apparatus utilizing the technology of electrophotography, that an elastic roller which comprises at least one elastic layer formed around an electrically conductive shaft and at least one covering layer formed on the outer surface of the elastic layer undergoes interfacial peeling possibly occurring when the roller rotates while contacting with other members. Using a curable composition comprising, as essential components, (A) an organic polymer containing, within the molecule, at least one alkenyl group capable of undergoing hydrosilylation but not containing an alkoxy group and/or an epoxy group, (B) a compound containing at least two hydrosilyl groups within the molecule, (C) a hydrosilylation catalyst and (D) a compound containing the structure represented by the general formula (1);
M-OR (1) (wherein M is an atom selected from a silicon atom, an aluminum atom and a titanium atom, and R is alkyl, alkenyl or the like groups); and/or an epoxy group structure, has led to a solution of the above subject.

### TECHNICAL FIELD

This invention relates to a curable composition which, upon being cured, can give an elastomer capable of adhering to the surface of another material, or to the field of technology of curable compositions for the manufacture of elastic rollers to be incorporated in image forming apparatus such as electrophotograpic copiers, laser beam printers, facsimiles, composite office automation appliances comprising these or the like, in which the technology of electrophotography is utilized.

### BACKGROUND ART

In the above-mentioned technical field, such rollers are used as charging rollers, developing rollers, fixing rollers and the like, and they are required to have different characteristics according to the respective uses. These rollers are each provided with a plurality of resin layers around a conductive shaft according to the characteristics required. For example, a low-hardness elastic layer is provided for the purpose of securing a nip width on the occasion of contacting with another member. The elastic layer is provided externally with a covering layer for preventing bleeding of low-molecular-weight components contained in the elastic layer onto the roller surface, for suppressing the stickiness of the roller surface, or for other purposes according to the respective uses of the rollers. In this manner, rollers adapted for various purposes have been proposed by providing each layer with independent characteristics. In the case of rollers provided with a plurality of layers, the adhesion in the interface between the respective two neighboring layers becomes very important. This is because when the roller rotates while contacting with another member, contacting-due friction occurs on the roller surface and, in the layer interface weak in adhesion, the covering layer may peel off.

In recent years, the adaptation of electrophotographic printers, copiers and the like OA appliances to higher speed operation has been rapidly going on, and it has come to be demanded that improvements be made in the interfacial adhesion between the core bar and elastic layer and between the elastic layer and covering layer, etc. of rollers to be installed in OA appliances. An increase in the speed of operation of an OA appliance, namely an increase in the number of prints per minute, means that the number of roller revolutions per minute also increases; the roller surface suffers stronger stress than before, so that peeling may occur from those layer interface sites where the adhesion is insufficient, possibly causing deteriorations in image quality. For solving such problems, a method for improving the adhesion between the core bar and elastic layer which comprises adding an epoxy group-containing organosilicon compound to the elastic layer (Japanese Kokai Publication Hei-11-231706) and a method for improving the adhesion between the elastic layer and covering layer which comprises applying a coupling agent on the elastic layer surface, followed by covering layer formation (Japanese Kokai Publication Hei-09-292767) have been respectively proposed. Certain technologies of improving the adhesion of the elastic layer and covering layer have thus been already proposed. Further improvements in adhesion as compared with the conventional technologies have been expected, however, in view of the current trend toward higher speeds of operation of OA appliances.

### SUMMARY OF THE INVENTION

It is an object of the present invention, which has been made in view of the above-discussed state of the art, to provide a curable composition capable of providing the elastic layer of a roller for use in an electrophotographic process which comprises an electrically conductive shaft, at least one elastic layer around the same and at least one covering layer formed on the outer surface of the elastic layer and is prevented from undergoing interfacial peeling possibly occurring when the roller rotates while contacting with other members, as well as an elastic roller produced using that composition.

The present inventors made intensive investigations in an attempt to solve the problems mentioned above and found that when use is made of a curable composition comprising (A) an organic polymer containing, within the molecule, at least one alkenyl group capable of undergoing hydrosilylation but not containing at least one group selected from an alkoxy group and an epoxy group, (B) a compound containing at least two hydrosilyl groups within the molecule, (C) a hydrosilylation catalyst and (D) a compound containing at least one structure selected from the structure represented by the general formula (1);
M-OR (1)
(wherein M is an atom selected from a silicon atom, an aluminum atom and a titanium atom, and R is a hydrocarbon group); and an epoxy group structure, the adhesion between the elastic layer made from the curable composition and the covering layer surrounding the elastic layer can be improved and the interfacial peeling between the elastic layer and covering layer can be thereby prevented. Such and other findings have led to completion of the present invention.

In an embodiment of the invention, the weight ratio between the component (A) and the component (D) is preferably within the range of 90.0:10.0 to 99.7:0.3.

In an embodiment, the component (D) preferably contains, within the molecule, at least one alkenyl group capable of undergoing hydrosilylation.

In an embodiment, the three substituents bound to the double bond contained in the alkenyl group in the component (D) each is preferably a hydrogen atom.

In an embodiment, the component (B) is preferably reacted in advance with the component (D) containing, within the molecule, at least one alkenyl group capable of undergoing hydrosilylation for the synthesis of a component (E).

In an embodiment, the component (A) polymer preferably contains, at a molecule terminus, an alkenyl group capable of undergoing hydrosilylation.

In an embodiment, the component (A) organic polymer is preferably an oxyalkylene-based polymer.

In an embodiment, a conductivity providing agent (F) is preferably added to the curable composition.

In an embodiment, the rubber elastomer obtained by curing of the curable composition preferably has an Asker C hardness within the range of 20 to 800.

In an embodiment, at least one elastic layer derived from the curable composition is preferably provided around a conductive shaft.

In an embodiment, at least one covering layer is preferably provided around the outer surface of the elastic layer.

In an embodiment, the covering layer is preferably derived from a urethane bond-containing compound.

In an embodiment, the elastic layer surface is preferably treated with a primer and then a covering layer is formed thereon.

### DETAILED DESCRIPTION OF THE INVENTION

In the following, such embodiments of the present invention are described in detail.

The component (A) of the invention, namely the organic polymer containing, within the molecule, at least one alkenyl group capable of undergoing hydrosilylation but not containing at least one group selected from an alkoxy group and an epoxy group, contains at least one alkenyl group as an essential functional group and does not contain either one of an alkoxy group and an epoxy group and, in some cases, contains neither of them. Other functional groups can be selected from arbitrary functional groups, without any particular restriction.

The alkenyl group in the component (A) is not particularly restricted but may be any group containing a carbon-carbon double bond capable of undergoing hydrosilylation. As the alkenyl group, there may be mentioned aliphatic unsaturated hydrocarbon groups such as vinyl, allyl, methylvinyl, propenyl, butenyl, pentenyl, hexenyl and the like groups; cyclic unsaturated hydrocarbon groups such as cyclopropenyl, cyclobutenyl, cyclopentenyl, cyclohexenyl and the like groups; methacryl and the like groups. Suitably, alkenyl groups represented by the general formula (2);
H₂C═C(R¹)—CH₂— (2)
(wherein R¹ is a hydrogen atom or a methyl group); are particularly preferred from the good curability viewpoint. The component (A) preferably has the above-mentioned alkenyl group capable of undergoing hydrosilylation as is introduced thereinto at one or each polymer chain terminus. Such an alkenyl-terminated polymer is preferred since a large quantity of effective network chains can be formed in the finally cured product and thus a high-strength rubber-like cured product can easily be obtained.

Furthermore, the main chain of the component (A) is not particularly restricted but can be selected from arbitrary polymers. For example, there may be mentioned polyisoprene, polybutadiene, polyisobutylene, polychloroprene, polyoxyalkylenes, polysiloxanes, polysulfides, polyurethanes, polyacrylic acid esters and the like. These polymers may be used singly or in combination or in the form of copolymers. Polymers comprising oxyalkylene units, in particular, are easy to handle because of their low viscosity before curing and, when they are used in manufacturing elastic rollers, the cured products have a particularly flexible structure and therefore show their elastic effect satisfactorily even when the layer thickness is reduced; hence such polymers are preferred.

Such the oxyalkylene-based polymer to be used as the component (A) in the practice of the invention is a polymer having an oxyalkylene unit content, relative to all the main chain constituent units, of not lower than 30%, preferably not lower than 50%. As other unit species than the oxyalkylene units, there may be mentioned the units derived from compounds containing two or more active hydrogen atoms as used as starting materials in the polymer production, for example ethylene glycol, bisphenol compounds, glycerol, trimethylolpropane, pentaerythritol and like units. The oxyalkylene unit species need not comprise only one species. Thus, use may also be made of copolymers (inclusive of graft polymers) derived from ethylene oxide, propylene oxide, butylenes oxide or the like. From the viewpoint of environmental stability of electric characteristics, polymers whose main chain skeleton comprises oxypropylene units, which are relatively low in water absorption, or oxybutylenes units are preferred and, from the cost viewpoint, oxypropylene unit-based polymers are particularly preferred.

The polyoxyalkylene-based polymer such as mentioned above preferably has a number average molecular weight (GPC method, on the polystyrene equivalent basis) of 500 to 50,000 in view of the ease of handling thereof and the rubber elasticity after curing. When the number average molecular weight is lower than 500, it becomes difficult to obtain satisfactory mechanical characteristics (rubber hardness, elongation) or the like after curing of the curable composition. On the other hand, when the number average molecular weight is not lower than 50,000, the molecular weight per alkenyl group within the molecule becomes high and the reactivity decreases due to increased steric hindrance, often leading to insufficient curing; furthermore, the viscosity tends to become excessively high, leading to worsened workability.

The component (B), or the curing agent, may be a compound containing at least two hydrosilyl groups within the molecule. When the number of hydrosilyl groups contained within the molecule is excessive, a large quantity of hydrosilyl groups may easily remain in the cured product even after curing, causing the formation of voids or cracks. Therefore, that number is preferably adjusted to 50 or less and, from the viewpoint of controlling the rubber elasticity of the cured product and from the good storage stability viewpoint, that number is more preferably adjusted to 2 to 30. In the present invention, “to contain one hydrosilyl group” means “to contain one H bonded to Si”. Thus, in the case of SiH₂, this group has two hydrosilyl groups. From the curability and rubber elasticity viewpoint, however, it is preferred that the H atoms bonded to Si be bound to different Si atoms.

From the good molding workability viewpoint, the molecular weight of such a curing agent is preferably adjusted to a level not higher than 30,000 as expressed in terms of number average molecular weight (Mn) and, from the viewpoint of good reactivity and compatibility with the above-mentioned base polymer, the molecular weight is more preferably adjusted to 300 to 10,000 as expressed in terms of Mn.

Considering the fact that the cohesive force of the base polymer is greater than that of the curing agent, it is important, from the compatibility viewpoint, that the curing agent should comprise a phenyl group modification. Styrene modifications are suitable from the ready availability viewpoint, and a-methylstyrene modifications are suitable from the storage stability viewpoint.

The component (C), namely the hydrosilylation catalyst, is not particularly restricted but any arbitrary one can be used. Specific examples are chloroplatinic acid, platinum as simple substance, solid platinum supported on such a carrier as alumina, silica, carbon black or the like; platinum-vinylsiloxane complexes {for example, Ptₙ(ViMe₂SiOSiMe₂Vi)ₘ, Pt[(MeViSiO)₄]ₘ}; platinum-phosphine complexes {for example, Pt(PPh₃)₄, Pt(PBu₃)₄}; platinum-phosphite complexes {for example, Pt[P(OPh)₃]₄, Pt[P(OBu)₃]₄} (in the above formulas, Me represents a methyl group, Bu represents a butyl group, Vi represents a vinyl group, Ph represents a phenyl group, n and m each represents an integer), Pt(acac)₂ and, furthermore, platinum-hydrocarbon complexes described by Ashby et al. in U.S. Pat. Nos. 3,159,601 and 3,159,662 as well as platinum alcoholate catalysts described by Lamoreaux et al. in U.S. Pat. No. 3,220,972.

As examples of other catalysts than platinum compounds, there may be mentioned RhCl(PPh₃)₃, RhCl₃, Rh/Al₂O₃, RuCl₃, IrCl₃, FeCl₃, AlCl₃, PdCl₂.2H₂O, NiCl₂, TiCl₄ and the like. These catalysts may be used singly or two or more of them may be used in combination. Preferred from the catalyst activity viewpoint are chloroplatinic acid, platinum-olefin complexes, platinum-vinylsiloxane complexes, Pt(acac)₂ and the like. The amount of the catalyst is not particularly restricted but is preferably within the range of 10⁻¹ to 10⁻⁸ moles per mole of the alkenyl group in the component (A). For the hydrosilylation reaction to proceed to a sufficient extent, the catalyst is more preferably used in an amount within the range of 10⁻² to 10⁻⁶ moles. Since the hydrosilylation catalysts are generally expensive and corrosive and, in some instances, cause the generation of large amounts of hydrogen gas to thereby cause the foaming of the cured product, the use in an amount exceeding 10⁻¹ moles is not recommended.

Now, the component (D) is described.

The compound containing at least one structure selected from the structure represented by the general formula (1);
M-OR (1)
(wherein M is an atom selected from a silicon atom, an aluminum atom and a titanium atom, and R is a hydrocarbon group); and the epoxy group structure is a compound containing at least one structure out of the above-mentioned M-OR and epoxy group within the molecule, and it may be a compound containing both the M-OR and epoxy group structures.

The structure represented by the general formula (1);
M-OR (1)
(wherein M is an atom selected from a silicon atom, an aluminum atom and a titanium atom, and R is a hydrocarbon group); is not particularly restricted but may refer to any compound containing, within the molecule, at least one atom (corresponding to M in general formula (1)) selected from a silicon atom, an aluminum atom and a titanium atom, with an alkoxy group being bound to said atom. The alkoxy group-forming alkyl or the like hydrocarbon groups (corresponding to R in general formula (1)) includes methyl, ethyl, n-propyl, isopropyl, n-butyl, sec-butyl, isobutyl, tert-butyl, n-hexyl, n-octyl, cyclohexyl, phenyl, toluyl and the like groups. As typical examples of such compound, there may be mentioned silane coupling agents, titanium coupling agents, and aluminum coupling agents.

The epoxy group-containing compound as the component (D) is not particularly restricted but may be any one having a functional group structure of the formula; 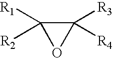
(wherein R₁ to R₄ each is an arbitrary organic group or a hydrogen atom); specifically epoxy groups such as glycidyl, alicyclic epoxy, aliphatic epoxy and the like epoxy groups. As the number of epoxy groups per molecule increases, the storage stability of the epoxy group-containing compound as the component (D) becomes worsened; therefore, the compound preferably contains 1 to 4 epoxy groups, more preferably 1 to 2 epoxy groups, in each molecule.

The weight ratio between the component (A) and the component (D) is preferably 90.0:10.0 to 99.7:0.3 and, furthermore, when that ratio is 95.0:5.0 to 99.5:0.5, two characteristics, namely elastic recovery of the elastic layer derived from the curable composition comprising the components (A) to (C) as essential components and improved adhesion between the elastic layer and covering layer owing to the addition of the component (D), can be properly acquired. When the level of addition of the component (D) is not more than 0.3 parts by weight, the adhesion between the elastic layer and covering layer unfavorably becomes insufficient and, conversely, at levels not less than 10.0 parts by weight, the compressive strain becomes unfavorably great.

For further improving the adhesion between the elastic layer and the covering layer, the component (D) preferably contains not only at least one structure selected from the structure represented by the general formula (1);
M-OR (1)
(wherein M is an atom selected from a silicon atom, an aluminum atom and a titanium atom, and R is a hydrocarbon group); and the epoxy group structure, but also at least one alkenyl group capable of undergoing hydrosilylation within the molecule. Presumably, the adhesion is improved as a result of the alkenyl group in component (D) reacting with the hydrosilyl group in component (B) and the alkoxy group and/or the epoxy group reacting or interacting with the covering layer.

The alkenyl group in component (D) is not particularly restricted but may be any group containing a carbon-carbon double bond capable of undergoing hydrosilylation. As the alkenyl group, there may be mentioned aliphatic unsaturated hydrocarbon groups such as vinyl, allyl, methylvinyl, propenyl, butenyl, pentenyl, hexenyl and the like groups; cyclic unsaturated hydrocarbon groups such as cyclopropenyl, cyclobutenyl, cyclopentenyl, cyclohexenyl and the like groups; methacryl and the like groups. When the component (D) does not react with the component (B) at all, it may possibly bleed out from the elastic body obtained from the curable composition and thereby contaminate other members and, furthermore, since it is not chemically bound to the hydrosilyl group of the component (B), poor adhesion to the covering layer will result. The occurrence of substituents on the alkenyl group to be hydrosilylated retards the hydrosilylation reaction, with the result that the amount of that portion of the component (D) which remains unreacted with the component (B) increases. Therefore, each of the three substituents on the double bond contained in the alkenyl group is particularly preferably a hydrogen atom. For example, vinyl, allyl and the like groups may be mentioned.

The component (E) is a compound obtained by preliminarily reacting the component (B) with the component (D) containing, within the molecule, at least one alkenyl group capable of undergoing hydrosilylation, and the component (C), namely the hydrosilylation catalyst, is essential for that reaction. Thus, the component (E) is synthesized by reacting the component (B) with the component (D) in advance and the unreacted portion of the component (D) is then removed in the after-treatment step. This is favorable since the bleeding of the unreacted component (D) from the elastic body can be prevented. From the compounding viewpoint, the component (E) synthesized preferably occurs as a liquid since it is necessary for the same to be further reacted with the components (A) and (C). For acquiring such properties, the component (D) to serve as a raw material for the preparation of the component (E) most preferably contains only one alkenyl group within the molecule since it constructs no crosslinked structure with the component (B). In cases where the component (E) is used in the curable composition, it is preferable that the proportions of the component (B) and the component (D) be adjusted so that the component (E) may contain at least two hydrosilyl groups, or the component (B) be further added to the curable composition comprising the components (E), (A) and (C) as essential components to thereby adjust the proportions, since the elastic roller made from the curable composition can be provided with a sufficient level of elasticity then.

In the case of rollers to be installed in OA appliances such as printers, copiers and the like, it is necessary to control the resistance thereof within the range from conductivity to semiconductivity and, therefore, a conductivity imparting agent is preferably added as a component (F) to the curable composition comprising the components (A), (B), (C) and (D) as essential components or the curable composition comprising the components (A), (C) and (E) as essential components. The conductivity imparting agent as the component (F) includes carbon black, metal oxides, fine metal powders and, furthermore, organic compounds or polymers containing a quaternary ammonium salt moiety, carboxylic acid group, sulfonic acid group, sulfate ester group, phosphate ester group and the like groups; conductive unit-containing compounds, typically etheresterimide or etherimide polymers, ethylene oxide-epihalohydrin copolymers, methoxypolyethylene glycol acrylate and the like; other antistatic agents for macromolecular compounds; and the like. In the practice of the invention, the component (F) may comprise single species or a combination of two or more species. As examples of the above-mentioned carbon black, there may be mentioned furnace black, acetylene black, lamp black, channel black, thermal black, oil black and the like. These carbon black species are not restricted in their kind or particle diameter, for example.

The level of addition of the component (F) is adjusted according to the desired conductivity characteristics and is preferably 0.01 to 100 parts by weight, more preferably 0.1 to 50 parts by weight, per 100 parts by weight of the component (A) polymer. At excessively low addition levels, the conductivity imparting ability is insufficient and, at excessively high addition levels, the viscosity of the curable composition increases remarkably, whereby the workability may be deteriorated. The hydrosilylation reaction may be inhibited by some conductivity imparting agents or at certain addition levels and, therefore, the effects of the candidate conductive imparting agent on the hydrosilylation reaction should preferably be taken into consideration.

In the practice of the invention, one or more of various fillers, various functionalizing agents, antioxidants, ultraviolet absorbers, pigments, surfactants and/or solvents may be added according to need. Specific examples of the fillers are fine silica powders, fine metal powders, calcium carbonate, clay, talc, titanium oxide, zinc white, diatomaceous earth, barium sulfate and the like.

In the curable composition of the invention, a storage stability improving agent can be incorporated for the purpose of improving the storage stability. This storage stability improving agent is not particularly restricted but may be any of the ordinary stabilizers known as the storage stabilizers for the component (B) to be used in the practice of the invention provided that the intended purpose can be accomplished. Specifically, use can properly be made of aliphatic unsaturated bond-containing compounds, organophosphorus compounds, organosulfur compounds, nitrogen-containing compounds, tin compounds, organic peroxides and the like. More specifically, the storage stability improving agent includes, but is not limited to, 2-benzothiazolyl sulfide, benzothiazole, thiazole, dimethyl acetylenedicarboxylate, diethyl acetylenedicarboxylate, butyl hydroxytoluene, butyl hydroxyanisole, vitamin E, 2-(4-morpholinyldithio)benzothiazole, 3-methyl-l-butene-3-ol, acetylenically unsaturated group-containing organosiloxanes, ethylenically unsaturated group-containing organosiloxanes, acetylenic alcohols, 3-methyl-1-butyl-3-ol, 3-methyl-1-pentyne-3-ol, diallyl fumarate, diallyl maleate, diethyl fumarate, diethyl maleate, dimethyl maleate, 2-pentenenitrile, 2,3-dichloropropene and the like.

For use in the field of rollers to be installed in image forming apparatus in which electrophotographic processes are utilized, as in the case of the present invention, the cured product obtained from the above-mentioned curable composition preferably has an Asker C hardness of 20 to 80° and, in particular, for use as developing rollers which transfer toners while contacting with another member, that hardness is preferably 30 to 70°. In the lower hardness region than the above range, the hardness is excessively low, so that the compressive strain becomes great. Conversely, in the higher hardness region, the hardness is excessively high, so that a great stress is unfavorably imposed on the toner.

The elastic roller produced using the curable composition of the invention is manufactured by forming an elastic layer comprising at least one layer made from the above-mentioned curable composition around a conductive shaft and submitted to use. The method for forming the elastic layer of the rubber roller is not particularly restricted but any of various roller molding methods known in the art may be used. For example, the conductive elastic layer is formed around the conductive shaft by molding the composition using a mold with the conductive shaft made of SUS stainless steel or the like, centrally located therein, using one of various molding methods such as extrusion molding, press molding, injection molding, reaction injection molding (RIM), liquid injection molding (LIM), cast molding and the like, followed by curing by heating at an appropriate temperature for an appropriate period of time. As for the method for manufacturing conductive rollers in the practice of the invention, when the curable composition for elastic layer formation occurs as a liquid, the liquid injection molding technique is preferred from the productivity and workability viewpoint. In this case, the curable composition may be once semicured and then completely cured by introducing a separate postcuring process.

Since the surface of the above-mentioned elastic layer is often provided with stickiness, at least one covering layer is preferably provided on the cylindrical outer surface of the elastic layer. A less sticky covering layer is preferably used as the covering layer.

The material of the covering layer is not particularly restricted but is required to be resistant to abrasion when it is used in rollers which rotate while contacting with another member. Therefore, the use of urethane bond-containing compounds excellent in abrasion resistance is preferred. Furthermore, the covering layer is required to have an appropriate degree of flexibility and, from this viewpoint, the covering layer is preferably made from a urethane resin composition whose main component is a resin having a polyether, polyester or polycarbonate skeleton. Such composition may be a blend resin comprising a polyether urethane, polyester urethane and polycarbonate urethane, or a composition based on a urethane resin containing, in each molecule, urethane bonds and at least one skeleton selected from the group consisting of polyether, polyester, polycarbonate and polysiloxane skeletons.

Furthermore, from the viewpoint of resistance adjustment, surface morphology adjustment, adhesion to the conductive elastic layer or the like, various additives such as conductivity imparting agents, various fillers and the like may be added to the surface layer-constituting resin composition according to need. For further improving the adhesion between the elastic layer made from the curable composition of the invention and the covering layer, the elastic layer surface is preferably treated with a primer prior to covering layer formation. Any primer containing various coupling agents or epoxy compounds can be used as the primer in the practice of the invention.

The method for covering layer formation in the practice of the invention is not particularly restricted but the covering layer can be formed on the cylindrical outer surface of the elastic layer formed around the conductive shaft by applying the covering layer-constituting resin composition onto that surface to a predetermined thickness using techniques such as the spray coating, dip coating, roll coating and the like, followed by drying and curing at respective predetermined temperatures. Specifically, a judicious method comprises applying a solution prepared by dissolving the resin to be used in forming the covering layer in a solvent to a solid concentration of 5 to 20% to the surface in question by spray or dip coating. The solvent to be used is not particularly restricted but may be any of those with which a main component of the resin to be used in forming the covering layer is compatible. Specific examples are methyl ethyl ketone, butyl acetate, ethyl acetate, N,N-dimethylformamide, toluene, isopropanol, water and the like. When the covering layer is formed using a urethane resin, in particular, N,N-dimethylformamide and N,N-dimethylacetamide are preferred from the compatibility viewpoint. As for the covering layer drying temperature, the range of 70 to 200° C. is preferred. At drying temperatures lower than 70° C., the drying may become insufficient and, at temperatures higher than 200° C., the inside elastic layer may be deteriorated. The covering layer thickness is not particularly restricted but is to be selected at an appropriate value according to the material employed, the composition thereof, the intended use and the like; generally, a thickness of 1 to 100 μm is preferred. When it is thinner than 1 μm, the abrasion resistance is low and the long-term durability tends to decrease. When it is thicker than 100 μm, problems tend to arise; for example, wrinkling may easily occur due to the difference in coefficient of linear expansion from the elastic layer, or the compressive strain may become increased. The covering layer thickness may be adjusted by repeating such a technique as spraying, dipping or the like several times to add several layers of the covering composition. In the practice of the invention, various additives such as leveling agents and the like may be added according to need to improve the film forming properties of the coating layer solution.

### BEST MODES FOR CARRYING OUT THE INVENTION

The following non-limitative examples further illustrate the present invention.

### EXAMPLE 1

A mixture was prepared by kneading 500 g of allyl-terminated polyoxypropylene (product name: ACX004-N, manufactured by Kaneka Corporation; corresponding to component A) with 70 g of Carbon Black #3030B (manufactured by Mitsubishi Chemical Corporation; corresponding to component F) using a 3-roll mill. Then, 16 g of polyorganohydrogensiloxane (product name: CR100, manufactured by Kaneka Corporation; corresponding to component B), 350 μL of a bis(1,3-divinyl-1,1,3,3-tetramethyldisiloxane)-platinum complex catalyst (platinum content 3% by weight, xylene solution; corresponding to component C), 170 μL of dimethyl maleate-and 5 g of tetraethoxysilane (corresponding to component D) were uniformly admixed with the mixture mentioned above. The resulting curable composition was debubbled using a vacuum debubbling agitator (manufactured by Sea-tec Co., Ltd.) for 90 minutes. This curable composition was injected into a mold (inside diameter 16 mm) with a SUS stainless steel shaft having a diameter of 8 mm being disposed therein, and the mold was allowed to stand in an environment maintained at 140° C. for 20 minutes to effect curing. The ASKER-C hardness of the thus-obtained elastic layer roller was as shown in Table 1. Then, a covering layer coating liquid was prepared by admixing 100 g of a urethane resin solution (product name: Himuren Y-258, manufactured by Dainichiseika Color & Chemicals Mfg. Co., Ltd.) and 300 g of N,N-dimethylformamide with a mixture prepared by kneading 12 g of Carbon Black #3030B (manufactured by Mitsubishi Chemical Corporation) with 150 g of methyl ethyl ketone in a bead mill. The coating liquid was applied by dipping, followed by 5 minutes of drying at 140° C. The same application procedure was repeated once more and, in addition, drying was performed at 160° C. for 90 minutes. A covering layer was provided. The thus-obtained roller was set in a color printer cartridge (EP-85, manufactured by Canon Inc.) and the cartridge was installed in a color printer (LASER SHOT LBP-2510, manufactured by Canon Inc.) and, after output of 10,000 image copies, the extent of interfacial peeling between the roller elastic layer and covering layer was judged by the eye. The result of observations about peeling is shown in Table 1.

### EXAMPLE 2

A mixture was prepared by kneading 500 g of allyl-terminated polyoxypropylene (product name: ACX004-N, manufactured by Kaneka Corporation; corresponding to component A) with 70 g of #3030B (manufactured by Mitsubishi Chemical Corporation; corresponding to component F) using a 3-roll mill. Then, 16 g of polyorganohydrogensiloxane (product name: CR100, manufactured by Kaneka Corporation; corresponding to component B), 350 μL of a bis(1,3-divinyl-1,1,3,3-tetramethyldisiloxane)-platinum complex catalyst (platinum content 3% by weight, xylene solution; corresponding to component C), 170 μL of dimethyl maleate and 5 g of acetoalkoxyaluminum diisopropylate (product name: AL-M, manufactured by Ajinomoto Fine-Techno. Co. Inc; corresponding to component D) were uniformly admixed with the mixture mentioned above. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 3

A mixture was prepared by kneading 500 g of allyl-terminated polyoxypropylene (product name: ACX004-N, manufactured by Kaneka Corporation; corresponding to component A) with 70 g of #3030B (manufactured by Mitsubishi Chemical Corporation; corresponding to component F) using a 3-roll mill. Then, 16 g of polyorganohydrogensiloxane (product name: CR100, manufactured by Kaneka Corporation; corresponding to component B), 350 μL of a bis(1,3-divinyl-1,1,3,3-tetramethyldisiloxane)-platinum complex catalyst (platinum content 3% by weight, xylene solution; corresponding to component C), 170 μL of dimethyl maleate and 5 g of tetrabutoxytitanium (corresponding to component D) were uniformly admixed with the mixture mentioned above. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 4

A mixture was prepared by kneading 495 g of allyl-terminated polyoxypropylene (product name: ACX004-N, manufactured by Kaneka Corporation; corresponding to component A) with 70 g of #3030B (manufactured by Mitsubishi Chemical Corporation; corresponding to component F) using a 3-roll mill. Then, 19 g of polyorganohydrogensiloxane (product name: CR100, manufactured by Kaneka Corporation; corresponding to component B), 430 μL of a bis(1,3-divinyl-1,1,3,3-tetramethyldisiloxane)-platinum complex catalyst (platinum content 3% by weight, xylene solution; corresponding to component C), 210 μL of dimethyl maleate and 5 g of trimethoxyvinylsilane (corresponding to component D) were uniformly admixed with the mixture mentioned above. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 5

A solution (hereinafter, “solution a”) prepared from 16 g of polyorganohydrogensiloxane (product name: CR100, manufactured by Kaneka Corporation; corresponding to component B) and 30 g of toluene was heated to 100° C., and a solution composed of 5 g of trimethoxyvinylsilane (corresponding to component D), 150 μL of a bis(1,3-divinyl-1,1,3,3-tetramethyldisiloxane)-platinum complex catalyst (platinum content 3% by weight, xylene solution; corresponding to component C) and 10 g of toluene was added dropwise to the solution a with stirring. After 5 hours of stirring, the toluene and unreacted trimethoxyvinylsilane were distilled off under reduced pressure, whereupon a component (E) was obtained. Then, a mixture prepared by kneading 495 g of allyl-terminated polyoxypropylene (product name: ACX004-N, manufactured by Kaneka Corporation; corresponding to component A) with 70 g of Carbon Black #3030B (manufactured by Mitsubishi Chemical Corporation; corresponding to component F) using a 3-roll mill was uniformly admixed with the component (E), 280 μL of a bis(1,3-divinyl-1,1,3,3-tetramethyldisiloxane)platinum complex catalyst (platinum content 3% by weight, xylene solution; corresponding to component C) and 140 μL of dimethyl maleate. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 6

A primer solution prepared from 2 g of A-187 (manufactured by Nippon Unicar Co., Ltd.), 2 g of tetrabutoxytitanium and 100 g of methyl ethyl ketone was uniformly applied, using a brush, to the surface of an elastic layer roller obtained by using the same curable composition as in Example 1, followed by drying under the conditions of 100° C. for 3 minutes. The elastic layer roller primer-treated in that manner was provided with a covering layer by dipping application in the same manner as in Example 1, and the roller obtained was tested for interfacial peeling between the elastic layer and the covering layer. The test results are summarized in Table 1.

### EXAMPLE 7

A primer solution prepared from 2 g of A-187 (manufactured by Nippon Unicar Co., Ltd.), 2 g of tetrabutoxytitanium and 100 g of methyl ethyl ketone was uniformly applied, using a brush, to the surface of an elastic layer roller obtained by using the same curable composition as in Example 4, followed by drying under the conditions of 100° C. for 3 minutes. The elastic layer roller primer-treated in that manner was provided with a covering layer by dipping application in the same manner as in Example 1, and the roller obtained was tested for interfacial peeling between the elastic layer and the covering layer. The test results are summarized in Table 1.

### EXAMPLE 8

A mixture was prepared by kneading 495 g of allyl-terminated polyoxypropylene (product name: ACX004-N, manufactured by Kaneka Corporation; corresponding to component A) with 70 g of Carbon Black #3030B (manufactured by Mitsubishi Chemical Corporation; corresponding to component F) using a 3-roll mill. Then, 21 g of polyorganohydrogensiloxane (product name: CR100, manufactured by Kaneka Corporation; corresponding to component B), 480 μL of a bis(1,3-divinyl-1,1,3,3-tetramethyldisiloxane)-platinum complex catalyst (platinum content 3% by weight, xylene solution; corresponding to component C), 240 μL of dimethyl maleate and 5 g of allyl glycidyl ether (corresponding to component D) were uniformly admixed with the mixture mentioned above. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 9

A mixture was prepared by kneading 495 g of allyl-terminated polyoxypropylene (product name: ACX004-N, manufactured by Kaneka Corporation; corresponding to component A) with 70 g of #3030B (manufactured by Mitsubishi Chemical Corporation; corresponding to component F) using a 3-roll mill. Then, 21 g of polyorganohydrogensiloxane (product name: CR100, manufactured by Kaneka Corporation; corresponding to component B), 480 μL of a bis(1,3-divinyl-1,1,3,3-tetramethyldisiloxane)-platinum complex catalyst (platinum content 3% by weight, xylene solution; corresponding to component C), 240 μL of dimethyl maleate and 5 g of 4-vinylcyclohexene oxide (corresponding to component D) were uniformly admixed with the mixture mentioned above. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 10

A solution (hereinafter, “solution a”) prepared from 21 g of polyorganohydrogensiloxane (product name: CR100, manufactured by Kaneka Corporation; corresponding to component B) and 30 g of toluene was heated to 100° C., and a solution composed of 5 g of allyl glycidyl ether (corresponding to component D), 200 μL of a bis(1,3-divinyl-1,1,3,3-tetramethyldisiloxane)-platinum complex catalyst (platinum content 3% by weight, xylene solution; corresponding to component C) and 10 g of toluene was added dropwise to the solution a with stirring. After 5 hours of stirring, the toluene and unreacted allyl glycidyl ether were distilled off under reduced pressure, whereupon a component (E) was obtained. Then, a mixture prepared by kneading 495 g of allyl-terminated polyoxypropylene (product name: ACX004-N, manufactured by Kaneka Corporation; corresponding to component A) with 70 g of Carbon Black #3030B (manufactured by Mitsubishi Chemical Corporation; corresponding to component F) using a 3-roll mill was uniformly admixed with the component (E), 280 μL of a bis(1,3-divinyl-1,1,3,3-tetramethyldisiloxane)platinum complex catalyst (platinum content 3% by weight, xylene solution; corresponding to component C) and 240 μL of dimethyl maleate. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

### EXAMPLE 11

A primer solution prepared from 2 g of A-187 (manufactured by Nippon Unicar Co., Ltd.), 2 g of tetrabutoxytitanium and 100 g of methyl ethyl ketone was uniformly applied, using a brush, to the surface of an elastic layer roller obtained by using the same curable composition as in Example 8, followed by drying under the conditions of 100° C. for 3 minutes. The elastic layer roller primer-treated in that manner was provided with a covering layer by dipping application in the same manner as in Example 1, and the roller obtained was tested for interfacial peeling between the elastic layer and the covering layer. The test results are summarized in Table 1.

### COMPARATIVE EXAMPLE 1

A mixture was prepared by kneading 500 g of allyl-terminated polyoxypropylene (product name: ACX004-N, manufactured by Kaneka Corporation; corresponding to component A) with 70 g of #3030B (manufactured by Mitsubishi Chemical Corporation; corresponding to component F) using a 3-roll mill. Then, 16 g of polyorganohydrogensiloxane (product name: CR100, manufactured by Kaneka Corporation; corresponding to component B), 350 μL of a bis(l,3-divinyl-1,1,3,3-tetramethyldisiloxane)-platinum complex catalyst (platinum content 3% by weight, xylene solution; corresponding to component C) and 170 μL of dimethyl maleate were uniformly admixed with the mixture mentioned above. An elastic layer roller was manufactured in the same manner as in Example 1 and tested for ASKER-C hardness and, after roller covering layer formation in the same manner as in Example 1, the roller was tested for interfacial peeling between the elastic layer and the covering layer. The test results are summarized in Table 1.

TABLE 1

| | | Interfacial peeling |
|---|---|---|
| | Roller hardness | between an elastic layer |
| | (ASKER-C) | and a covering layer |
| Example 1 | 49 | No/wrinkling |
| Example 2 | 50 | No/wrinkling |
| Example 3 | 51 | No/wrinkling |
| Example 4 | 46 | No/manual peeling |
| Example 5 | 48 | No/manual peeling |
| Example 6 | Same as in Example 1 | No/manual peeling |
| Example 7 | Same as in Example 4 | No |
| Example 8 | 43 | No/manual peeling |
| Example 9 | 44 | No/manual peeling |
| Example 10 | 45 | No/manual peeling |
| Example 11 | Same as in Example 8 | No |
| Comparative | 49 | Peeling |
| Example 1 | | |

Covering layer peeling
“No”: No peeling occurred in the testing proper; attempted manual peeling failed completely.
“No/manual peeling”: No peeling occurred in the testing proper; manual peeling was possible, however.
“No/wrinkling”: No peeling occurred in the testing proper but slight wrinkling was observed on the covering layer.
“Peeling”: Peeling occurred.

### INDUSTRIAL APPLICABILITY

When the curable composition of the invention and the elastic roller made therefrom are used, the roller, when installed in an OA appliance such as an electrophotographic printer, copier and the like, can be prevented from undergoing peeling on the occasion of rotation thereof while contacting with another member.

1. A curable composition which comprises following components (A) to (D) as essential components.
(A) an organic polymer containing, within the molecule, at least one alkenyl group capable of undergoing hydrosilylation but not containing at least one group selected from an alkoxy group and an epoxy group,
(B) a compound containing at least two hydrosilyl groups within the molecule,
(C) a hydrosilylation catalyst and
(D) a compound containing at least one structure selected from the structure represented by the general formula (1);
M-OR (1)
(wherein M is an atom selected from a silicon atom, an aluminum atom and a titanium atom, and R is a hydrocarbon group); and an epoxy group structure.

2. The curable composition according to claim 1
wherein the weight ratio between the component (A) and the component (D) is within the range of 90.0:10.0 to 99.7:0.3.

3. The curable composition according to claim 1 or 2
wherein the component (D) contains, within the molecule, at least one alkenyl group capable of undergoing hydrosilylation.

4. The curable composition according to claim 3
wherein the three substituents bound to the double bond contained in the alkenyl group in the component (D) each is a hydrogen atom.

5. The curable composition according to claim 3
wherein the composition comprises a component (E) synthesized by reacting the component (B) in advance with the component (D) containing, within the molecule, at least one alkenyl group capable of undergoing hydrosilylation, the component (A) and the component (C) as essential components.

6. The curable composition according to any of claim 1 or 2
wherein the component (A) polymer contains, at a molecule terminus, an alkenyl group capable of undergoing hydrosilylation.

7. The curable composition according to any of claim 1 or 2
wherein the component (A) organic polymer is an oxyalkylene-based polymer.

8. The curable composition according to any of claim 1 or 2
wherein a conductivity providing agent (F) is added to the curable composition according to any of claims 1 to 7.

9. The curable composition according to any of claim 1 or 2
wherein an elastomer obtained by curing of the curable composition has an ASKER-C hardness within the range of 20 to 80°.

10. An elastic roller
wherein at least one elastic layer derived from the curable composition according to any of claim 1 or 2 is provided around a conductive shaft.

11. The elastic roller according to claim 10
wherein at least one covering layer is provided around the outer surface of the elastic layer.

12. The elastic roller according to claim 11
wherein the covering layer is derived from a urethane bond-containing compound.

13. The elastic roller according to claim 12
wherein the elastic layer surface is treated with a primer and then the covering layer is formed thereon.
